(19) United States
(12) Patent Application Publication
(10) Pub. No.: US 2026/0300453 A1
(43) Pub. Date: Oct. 1, 2026

(54) SYSTEMS AND METHODS FOR AUTOMATED LOGIN

(71) Applicant: Netflix, Inc., Los Gatos, CA (US)

(72) Inventors: Anthony DeVere Edwards, San Francisco, CA (US); Ye Yuan, San Francisco, CA (US); Charles Christian Wartemberg, Seattle, WA (US); Rajat Shah, San Jose, CA (US); Luis Antonio Medina, San Ramon, CA (US); Mamal Poladia, Sunnyvale, CA (US); Wei Wu, Kirkland, WA (US); Ece Manisali, Los Angeles, CA (US); Chanthru Kanna Chandran, Tracy, CA (US)

(21) Appl. No.: 19/091,497

(22) Filed: Mar. 26, 2025

(51) Int. Cl. G06F 21/31

(52) U.S. Cl. CPC G06F 21/31; G06F 2221/2111

(57) ABSTRACT

The disclosed computer-implemented method may include detecting, by a computing device, a login attempt from a client device to an online service. The method may include determining, based on a unique identifier of the client device, that the client device is associated with the online service. Additionally, the method may include determining that an attribute of the client device is associated with a primary location of a user account of the online service. The method may also include performing a security action for the login attempt based on the association with the user account. Furthermore, the method may include eliminating a requirement of one or more user credentials of the user account for the login attempt based on the security action. Finally, the method may include completing the login attempt to the online service for the client device. Various other methods, systems, and computer-readable media are also disclosed.

### BACKGROUND

Online platforms can provide various services and functions to users by enabling users to access the platforms using individual accounts. For example, a video streaming service can host videos that users can access and watch using personal computing devices. Users can create accounts and then log in to these accounts using any device. For example, a user can use a smart television (TV) to access the video streaming service by entering a username and then entering login credentials for their account. In some cases, online platforms can streamline the process to keep a user logged in to an account on a frequently used device, such as the home smart TV.

However, users may have multiple devices that are capable of accessing the same user account. For each new login, a user typically needs to manually add a new device to their account. These login processes can introduce friction for users who have difficulty remembering passwords or correctly entering credentials. This can further lead to frustration and errors in login that may lead to unsafe user behaviors. For example, users who frequently forget passwords may record the passwords and store them in unsafe ways. In some systems, login processes may attempt to provide alternative login methods, such as using a quick-response (QR) code to capture the login screen. However, this requires a secondary device capable of capturing QR codes, which may also create friction for users who prefer a more familiar login process. For example, users may be used to navigating a virtual keyboard to type in credentials rather than utilizing a second device and additional application for QR codes. On the other hand, without verifying user identity on new devices, simpler login processes may be prone to attacks or misuse of user accounts. Thus, better methods of streamlining user login and automating access to online services are needed to improve user experience without sacrificing security.

### SUMMARY

As will be described in greater detail below, the present disclosure describes systems and methods for automated login of devices. In one example, a computer-implemented method for automated login may include detecting, by a computing device, a login attempt from a client device to an online service. The method may also include determining, based on a unique identifier of the client device, that the client device is associated with the online service. In addition, the method may include determining, by the computing device, that an attribute of the client device is associated with a primary location of a user account of the online service. The method may also include performing, by the computing device, a security action for the login attempt based on the association with the user account. Furthermore, the method may include eliminating, by the computing device, a requirement of at least one user credential of the user account for the login attempt based on the security action. Finally, the method may include completing, by the computing device, the login attempt to the user account of the online service for the client device.

In one embodiment, detecting the login attempt may include detecting an initiation of a connection to the online service from the client device and/or identifying an initial user credential associated with the login attempt.

In one example, determining that the client device is associated with the online service may include comparing the unique identifier of the client device with a database of previous login attempts. In this example, the method may further include determining that the unique identifier of the client device does not match a previous login attempt and adding the unique identifier of the client device to the database of previous login attempts.

In some embodiments, determining that the attribute of the client device is associated with the primary location may include comparing the attribute of the client device with a location graph. In these embodiments, the location graph may include a clustering of client devices, wherein each cluster represents the primary location of a set of client devices in the cluster, such that each user account is associated with one primary location. Additionally, the location graph may cluster the client devices based on similar attributes of the client devices during previous login attempts for each user account. In the above embodiments, the method may further include updating the location graph with the unique identifier of the client device based on determining that the attribute of the client device is associated with the primary location.

In some examples, the attribute of the client device may include an Internet Protocol (IP) address and/or a direct connection to a different client device associated with the primary location of the user account. In these examples, the security action may include encrypting the login attempt, determining a risk of the IP address is below a predetermined threshold, verifying a security of the direct connection, and/or verifying a security status of the user account.

In one embodiment, the user credential may include a user identifier, an account identifier, a password, and/or a quick-response (QR) code.

In one example, completing the login attempt may further include performing an additional security action to verify the client device. In this example, the additional security action may include decrypting the login attempt, notifying, by the computing device, a user of the user account about the login attempt from the client device, and/or verifying a timestamp of the login attempt.

In some embodiments, the computer-implemented method may further include detecting, by the computing device, a new login attempt from the client device, determining that the client device was previously logged out by a user of the user account, performing a security check for the new login attempt, and completing, based on the security check, the new login attempt to the user account of the online service for the client device. In these embodiments, the security check may include requesting the at least one user credential of the user account during the new login attempt for the client device, evaluating a previous logout of the client device, and/or verifying a security status of the user account.

In addition, a corresponding system for automated login may include several modules stored in memory, including a detection module that detects, by a computing device, a login attempt from a client device to an online service. The system may also include a determination module that determines, based on a unique identifier of the client device, that the client device is associated with the online service. In addition, the system may include a location module that determines, by the computing device, that an attribute of the client device is associated with a primary location of a user account of the online service. The system may also include a security module that performs, by the computing device, a security action for the login attempt based on the association with the user account. Furthermore, the system may include an elimination module that eliminates, by the computing device, a requirement of at least one user credential of the user account for the login attempt based on the security action. Additionally, the system may include a login module that completes, by the computing device, the login attempt to the user account of the online service for the client device. Finally, the system may include one or more processors that execute the detection module, the determination module, the location module, the security module, the elimination module, and the login module.

In one embodiment, the detection module may further detect a new login attempt from the client device, the determination module may further determine that the client device was previously logged out by a user of the user account, the security module may further perform a security check for the new login attempt, and the login module may complete the new login attempt for the client device. In this embodiment, the security module may further determine the new login attempt from the client device is associated with a different user account of the online service, and the login module may complete the new login attempt to the different user account of the online service. In this embodiment, the location module may further adjust a location graph of client devices based on the security module determining the new login attempt is associated with the different user account.

In some examples, the above-described method may be encoded as computer-readable instructions on a non-transitory computer-readable medium. For example, a computer-readable medium may include one or more computer-executable instructions that, when executed by at least one processor of a computing device, may cause the computing device to detect a login attempt from a client device to an online service. The instructions may also cause the computing device to determine, based on a unique identifier of the client device, that the client device is associated with the online service. In addition, the instructions may cause the computing device to determine that an attribute of the client device is associated with a primary location of a user account of the online service. The instructions may also cause the computing device to perform a security action for the login attempt based on the association with the user account. Furthermore, the instructions may cause the computing device to eliminate a requirement of at least one user credential of the user account for the login attempt based on the security action. Finally, the instructions may cause the computing device to complete, by the computing device, the login attempt to the user account of the online service for the client device.

Features from any of the embodiments described herein may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is a flow diagram of an exemplary method for automated login.

FIG. 2 is a block diagram of an exemplary computing system for automated login.

FIG. 3 is a flow diagram of an exemplary login process.

FIG. 4 is a block diagram of an exemplary display sequence for user login.

FIG. 5 is a block diagram of an exemplary location graph of client devices.

FIG. 6 is a block diagram of an exemplary display for prompting user credentials.

FIG. 7 is a block diagram of an exemplary adjustment of a location graph.

FIG. 8 is a block diagram of an exemplary content distribution ecosystem.

FIG. 9 is a block diagram of an exemplary distribution infrastructure within the content distribution ecosystem shown in FIG. 8.

FIG. 10 is a block diagram of an exemplary content player within the content distribution ecosystem shown in FIG. 8.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

The present disclosure is generally directed to automatically logging in users to an online service. As will be explained in greater detail below, embodiments of the present disclosure may, by predicting primary locations of user accounts, reduce friction to simplify a login process for users of an online service. The disclosed systems and methods first detect a client device attempting to access an online service and determine the device is associated with the online service. For example, the disclosed systems and methods may compare a unique identifier of the client device, such as an electronic serial number (ESN), with a list of known client devices to determine if the client device has previously been used by any user or not. In some examples, the disclosed systems and methods may prompt a user for an initial user credential. For example, the systems and methods described herein may collect, as part of the attempt to access the online service, a username or account information. In some examples, the systems and methods described herein also collect device information, such as the unique identifier, and network connection details, such as an Internet Protocol (IP) address.

The disclosed systems and methods then compare the client device information with a location graph to determine whether the client device is part of a known primary location of a user account. For example, the systems and methods described herein can generate the location graph based on previous login attempts from various devices and user accounts to identify shared connection information, such as shared IP addresses. In this example, the disclosed systems and methods can use the shared connection information to determine which devices are likely linked by location and belong to the same user or user account. By clustering devices based on shared locations, the systems and methods described herein can identify the primary location set by each user account and the associated client devices and location data. In addition, by comparing the details of the client device with known clusters, the disclosed systems and methods may determine the client device likely belongs to a cluster representing the primary location of a user account. Furthermore, the disclosed systems and methods can evaluate whether the location data is low risk, such as whether an IP address is likely to be non-public. For login attempts that pass the additional security checks, the disclosed systems and methods can bypass requesting additional user credentials, such as passwords, to automatically log in the user. In some examples, the disclosed systems and methods may forgo requiring an initial user credential or username when the location of a new device can be verified for a user account without user credentials. For example, the disclosed systems and methods can detect, from a user navigating to an online service webpage or software application, that the client device is new and is located in a known primary location.

The systems and methods described herein may improve the functioning of a computing device by simplifying the process to validate a client device for user login to an online service. For example, the disclosed systems and methods can validate client devices based on detecting location information and comparing the information to known primary locations of user accounts, thereby enabling the validation of client devices, such as devices of certain types, that are added to the primary location. The systems and methods described herein can then perform one or more security actions, such as encrypting the login attempt decision, to utilize existing security applications and upstream security functions for the login attempt. By performing additional security actions to evaluate the client device and the login attempt, the disclosed systems and methods can provide backend security while reducing friction for users in the login process. In addition, these systems and methods may improve the fields of network security and account security by managing the location graph for device detection. For example, by evaluating the details of the client device and comparing them to a location graph, the disclosed systems and methods improve server security to provide stateless security that does not require management of server-side states to provide login security. As another example, by building static rules informed by the location graph, the systems and methods described herein improve the ease and speed of evaluating login attempts to decrease latency and increase accuracy in user login. Thus, the disclosed systems and methods may improve over traditional methods of login that require more manual user input and increase points of failure.

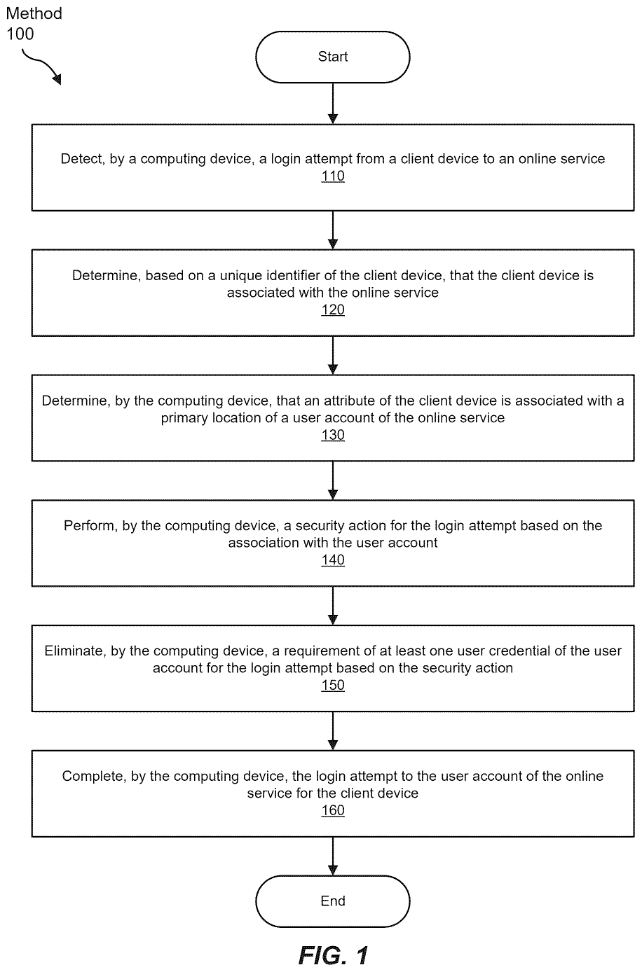

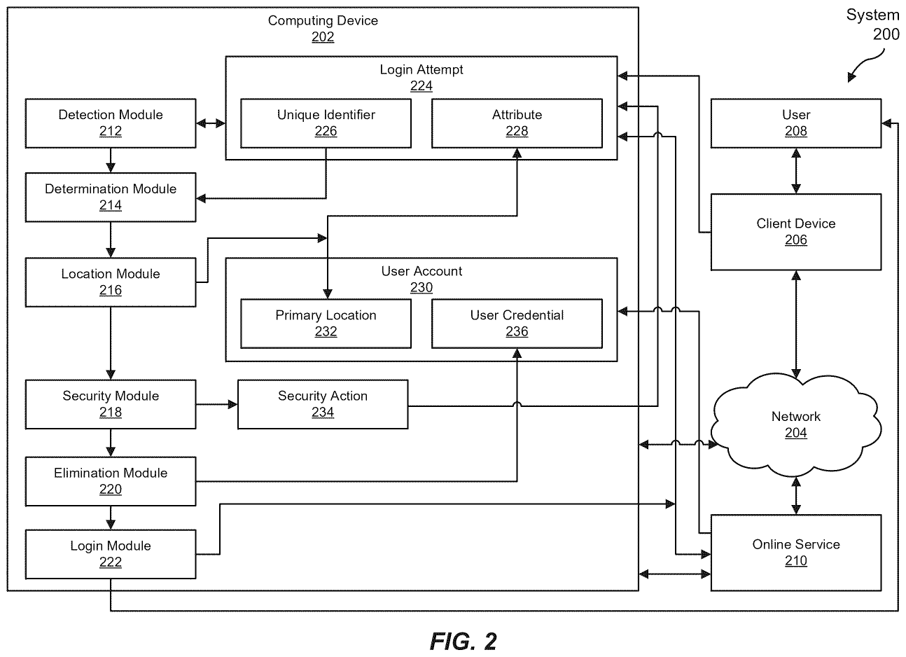

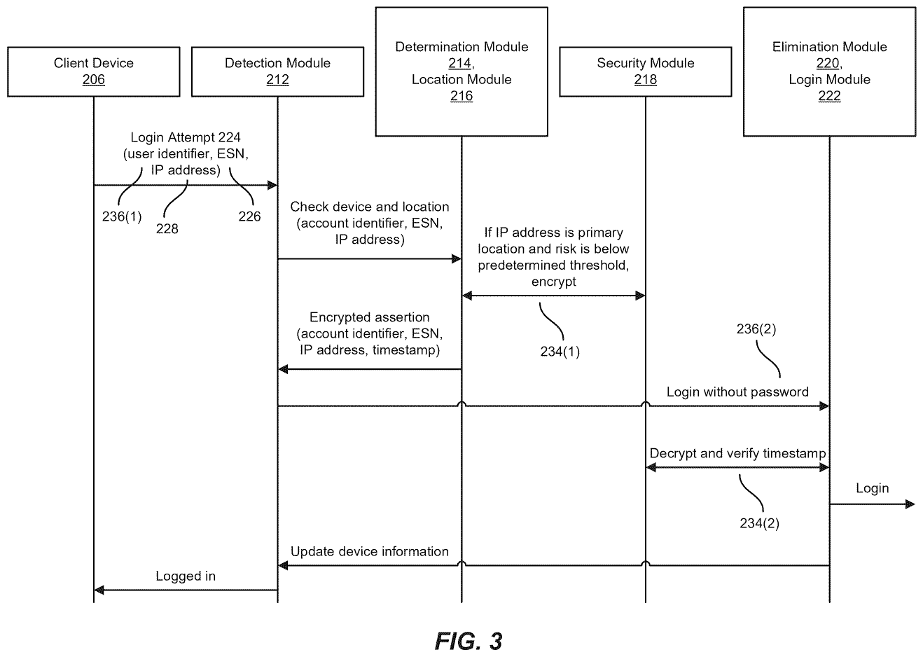

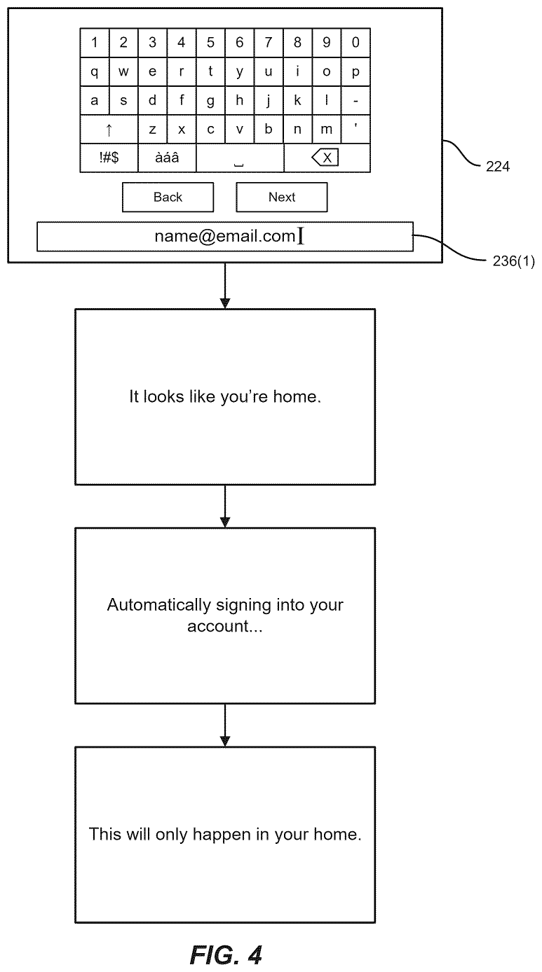

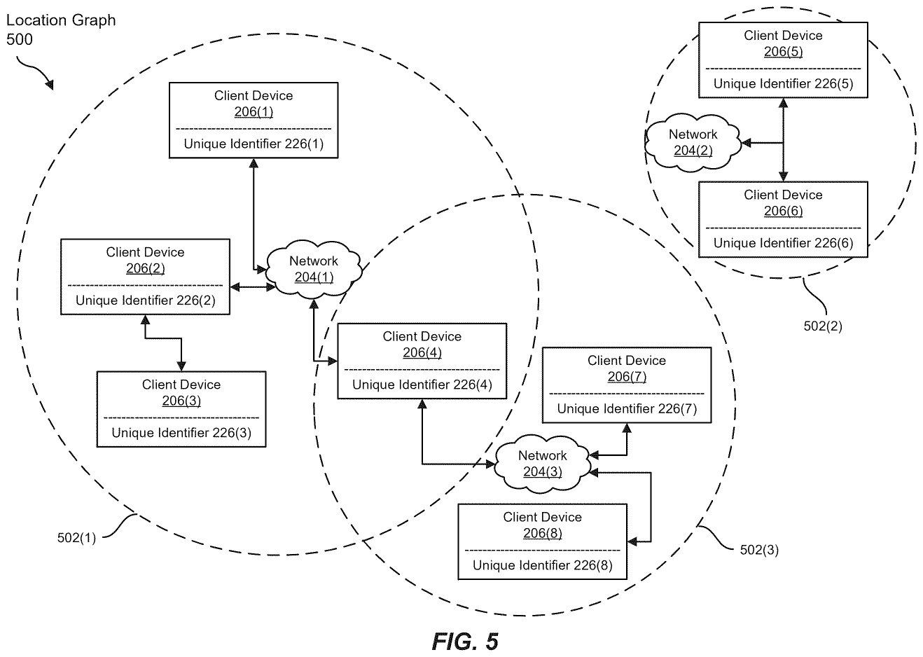

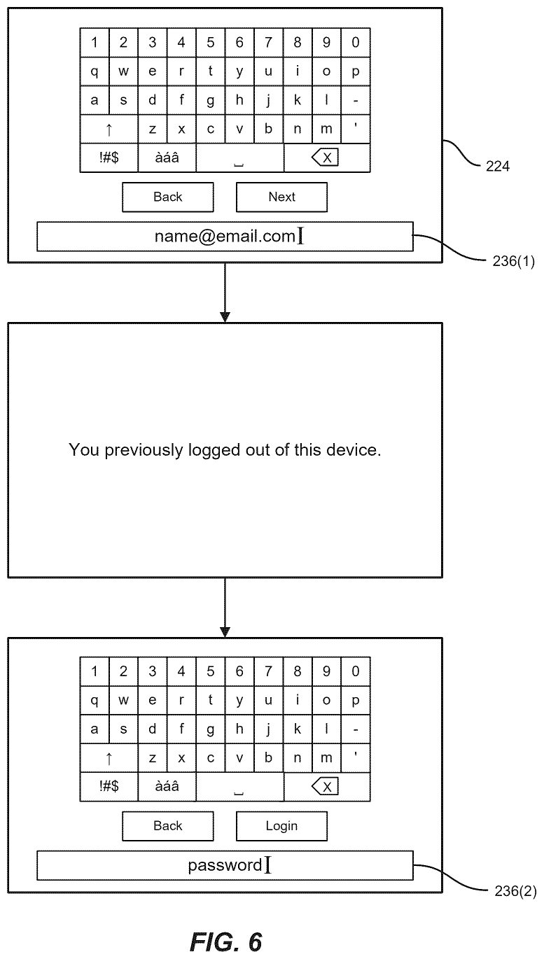

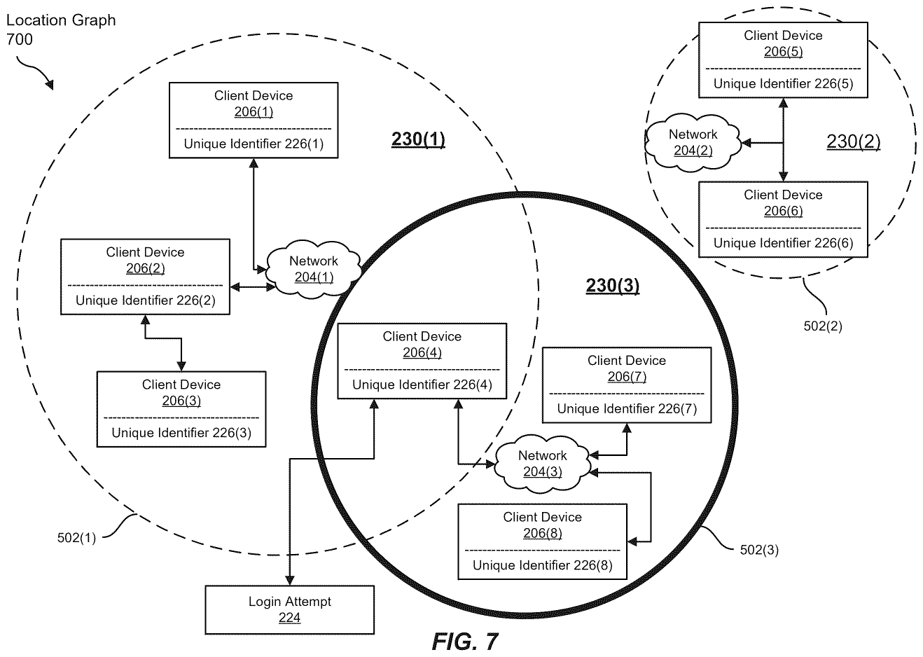

Thereafter, the description will provide, with reference to FIG. 1, detailed descriptions of computer-implemented methods for automated login. Detailed descriptions of a corresponding exemplary computing system will be provided in connection with FIG. 2. Detailed descriptions of an exemplary login process will be provided in connection with FIG. 3. In addition, detailed descriptions of an exemplary display sequence for user login will be provided in connection with FIG. 4. Detailed descriptions of an exemplary location graph of client devices will be provided in connection with FIG. 5. Furthermore, detailed descriptions of an exemplary display for prompting user credentials will be provided in connection with FIG. 6. Additionally, detailed descriptions of an exemplary adjustment of a location graph will be provided in connection with FIG. 7.

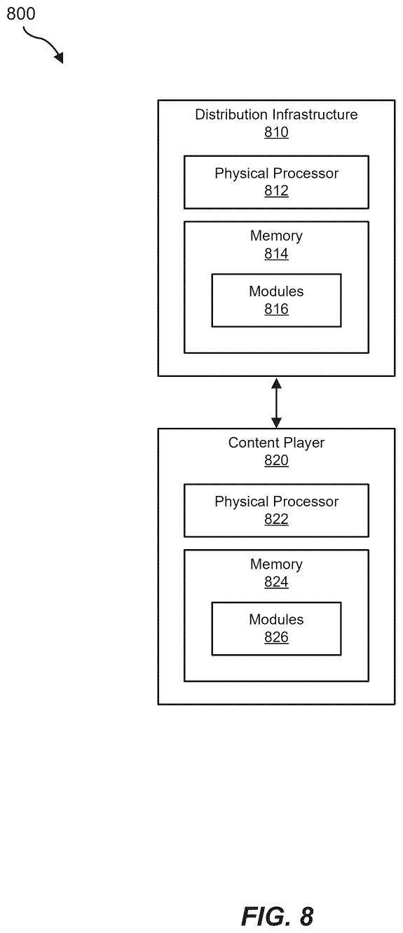

Because many of the embodiments described herein may be used with substantially any type of computing network, including distributed networks designed to provide video content to a worldwide audience, various computer network and video distribution systems will initially be described with reference to FIGS. 8-10. These figures will introduce the various networks and distribution methods used to provision video content to users.

FIG. 1 is a flow diagram of an exemplary computer-implemented method 100 for automated login. The steps shown in FIG. 1 may be performed by any suitable computer-executable code and/or computing system, including the systems illustrated in FIGS. 8-10, computing device 202 in FIG. 2, or a combination of one or more of the same. In one example, each of the steps shown in FIG. 1 may represent an algorithm whose structure includes and/or is represented by multiple sub-steps, examples of which will be provided in greater detail below. In some examples, all of the steps and sub-steps represented in FIG. 1 may be performed by one device (e.g., either a server or a client computing device). Alternatively, the steps and/or substeps represented in FIG. 1 may be performed across multiples devices (e.g., some of steps and/or sub-steps may be performed by a server and other steps and/or sub-steps may be performed by a client computing device).

As illustrated in FIG. 1, at step 110, one or more of the systems described herein may detect, by a computing device, a login attempt from a client device to an online service. For example, FIG. 2 is a block diagram of an exemplary system 200 for automated login. As illustrated in FIG. 2, a detection module 212 may, as part of a computing device 202, detect a login attempt 224 from a client device 206 to an online service 210.

In some embodiments, computing device 202 may generally represent a device capable of processing user and/or device data to determine a correlation between a client device and a user account of an online service, such as a content hosting platform. Computing device 202 may alternatively generally represent any type or form of server that is capable of storing and/or managing content and user data, such as user account 230 and/or videos for a video hosting platform. Examples of a server include, without limitation, security servers, application servers, web servers, storage servers, streaming servers, and/or database servers configured to run certain software applications and/or to provide various security, web, storage, streaming, and/or database services. Additionally, computing device 202 may include distribution infrastructure 810 and/or various other components of FIGS. 8-10.

Although illustrated as part of computing device 202 in FIG. 2, some or all of the modules described herein may alternatively be executed by a separate server or any other suitable computing device. For example, computing device 202 may represent a separate device for managing login attempts for online service 210 or, alternatively, may represent part of system 200 for providing online service 210 as a whole. For example, online service 210 may include multiple servers and/or computing devices that include computing device 202.

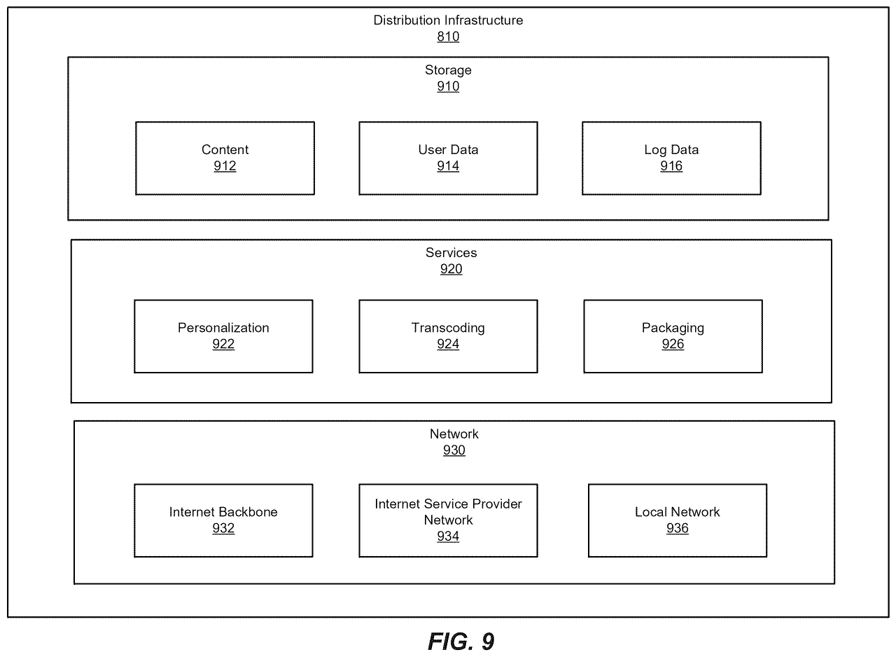

In the above embodiments, computing device 202 may be directly in communication with other servers and/or in communication with other computing devices, such as a client device 206 and/or online service 210, via a network, such as a network 204 of FIG. 2. In some examples, the term “network” may refer to any medium or architecture capable of facilitating communication or data transfer. Examples of networks include, without limitation, an intranet, a Wide Area Network (WAN), a Local Area Network (LAN), a Personal Area Network (PAN), the Internet, Power Line Communications (PLC), a cellular network (e.g., a Global System for Mobile Communications (GSM) network), network 930 of FIG. 9, or any other suitable network. For example, network 204 may facilitate data transfer between computing device 202 and client device 206 using wireless or wired connections and between computing device 202 and online service 210. In other examples, online service 210 may be hosted on computing device 202 or another device of system 200.

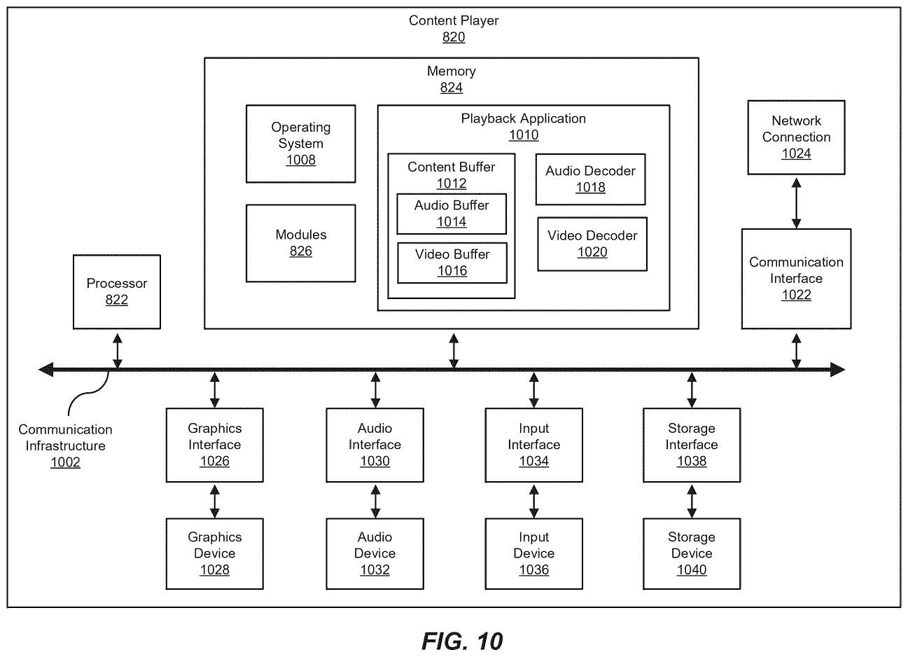

In some examples, client device 206 may generally represent any type or form of computing device capable of running computing software and applications. As used herein, the term “application” generally refers to a software program designed to perform specific functions or tasks and capable of being installed, deployed, executed, and/or otherwise implemented on a computing system. Examples of applications may include, without limitation, playback application 1010 of FIG. 10, productivity software, enterprise software, entertainment software, security applications, cloud-based applications, web applications, mobile applications, content access software, simulation software, integrated software, application packages, application suites, variations or combinations of one or more of the same, and/or any other suitable software application. Examples of client devices may include, without limitation, laptops, tablets, desktops, servers, cellular phones, Personal Digital Assistants (PDAs), multimedia players, embedded systems, wearable devices (e.g., smart watches, smart glasses, etc.), gaming consoles, combinations of one or more of the same, or any other suitable computing device. Additionally, client devices may include content player 820 in FIGS. 8 and 10 and/or various other components of FIGS. 8-10.

The systems described herein may perform step 110 in a variety of ways. As used herein, the term “online service” generally refers to a resource or service that is provided over a network, such as the Internet. Examples of online services may include, without limitation, Software as a Service (SaaS), Platform as a Service (PaaS), Infrastructure as a Service (IaaS), digital media streaming, file hosting services, electronic commerce services, variations or combinations of one or more of the same, distribution infrastructure 810 of FIGS. 8-9, and/or any other suitable web-based service. In some embodiments, detection module 212 detects login attempt 224 by detecting an initiation of a connection to online service 210 from client device 206 and/or by identifying an initial user credential associated with login attempt 224. As used herein, the term “user credential” generally refers to data that can verify or authenticate a user's identity and/or level of access. For example, an initial user credential may include a username or an account identifier to identify an account that a user 208 is attempting to access.

In the example of FIG. 3, login attempt 224 from client device 206 includes a user identifier as user credential 236(1). Similarly, in the example of FIG. 4, user 208 may enter an email address as an account identifier for a user credential 236(1) as part of login attempt 224. In other examples, login attempt 224 may include various other data, such as a user phone number, a device-bound passport containing specific information about login attempt 224, and/or other identifying information. In further examples, detection module 212 may detect login attempt 224 by detecting client device 206 accessing a resource of online service 210, such as by user 208 navigating to an application on client device 206 used to display streaming content from online service 210. In these examples, detection module 212 intercepts incoming attempts to connect to online service 210 as login attempts.

Returning to FIG. 1, at step 120, one or more of the systems described herein may determine, based on a unique identifier of the client device, that the client device is associated with the online service. For example, a determination module 214 may, as part of computing device 202 in FIG. 2, determine, based on a unique identifier 226 of client device 206, that client device 206 is associated with online service 210.

The systems described herein may perform step 120 in a variety of ways. In some examples, determination module 214 determines client device 206 is associated with online service 210 by comparing unique identifier 226 with a database of previous login attempts. In the example of FIG. 3, login attempt 224 includes an ESN of client device 206 as unique identifier 226. In other examples, unique identifier 226 can include alternative identification that distinguishes client devices. In the above examples, computing device 202 stores unique identifiers of each client device attempting to login to online service 210 in the database of previous login attempt. In some examples, for a new client device, determination module 214 determines that unique identifier 226 does not match a previous login attempt, and computing device 202 adds unique identifier 226 of client device 206 to the database of previous login attempts. In alternate examples, the database of previous login attempts may be stored on a separate device or server, and determination module 214 may access the separate device or server to compare unique identifier 226.

Returning to FIG. 1, at step 130, one or more of the systems described herein may determine, by the computing device, that an attribute of the client device is associated with a primary location of a user account of the online service. For example, a location module 216 may, as part of computing device 202 in FIG. 2, determine that an attribute 228 of client device 206 is associated with a primary location 232 of a user account 230 of online service 210.

The systems described herein may perform step 130 in a variety of ways. In one embodiment, location module 216 determines that attribute 228 is associated with primary location 232 by comparing attribute 228 with a location graph. In some embodiments, attribute 228 includes an Internet Protocol (IP) address and/or a direct connection to a different client device associated with primary location 232 of user account 230. In the example of FIG. 3, attribute 228 includes an IP address of client device 206. In this example, IP addresses can indicate a general geographic area or a shared physical location or connection of multiple client devices.

In some embodiments, the location graph includes a clustering of client devices, wherein each cluster represents the primary location of a set of client devices in the cluster, such that each user account is associated with one primary location. As used herein, the term “clustering” generally refers to a method of analyzing and grouping similar data and/or related objects to distinguish it from less similar data. Examples of clustering may include, without limitation, k-nearest neighbors (k-NN) algorithms, k-means clustering, expectation-maximization algorithms, hierarchical clustering, or any other suitable method. In these embodiments, the location graph clusters the client devices based on connections detected between the client devices, such as shared network connections. As used herein, the term “primary location” generally refers to a location designated as a preferred location by a user and/or determined by user account usage and clustering of client devices. For example, a primary location of a smart TV may be identified by the network connection and IP address of a user's home.

In some examples, computing device 202 further updates the location graph with unique identifier 226 of client device 206 based on determining that attribute 228 is associated with primary location 232. In these examples, client device 206 can be added to primary location 232 as part of user account 230 in the location graph.

As illustrated in FIG. 5, a location graph 500 represents a clustering of client devices 206(1)-(8) that have previously attempted to log in to online service 210 of FIG. 2. In this example, networks 204(1)-(3) may represent separate local networks using different IP addresses. Based on connections to networks 204(1)-(3) and direct connections between devices, such as between client device 206(2) and client device 206(3), location graph 500 loosely includes clusters 502(1)-(3). Additionally, based on login attempts to accounts of online service 210, each of clusters 502(1)-(3) represent a different primary location for a different user account. In some examples, clustering may depend on a level of confidence that a device is primarily tied to one user account or one location. For example, as shown in FIG. 5, client device 206(4) is not assigned to a specific primary location or user account based on past connections to both network 204(1) and network 204(3). Thus, client device 206(4) may represent a device in either cluster 502(1) or cluster 502(3). In this example, location module 216 may then determine that an IP address of client device 206 of FIG. 2 is the same IP address of network 204(3), indicating client device 206 is associated with primary location 232 of cluster 502(3).

In additional embodiments, location module 216 can use other attributes or a combination of attributes to cluster client devices. For example, a client device that logs in to a user account to continue streaming a video previously paused on a different client device can tie the two client devices to the same user account. As another example, a mobile phone used to scan a QR code to log in on a smart TV can tie the mobile phone and smart TV to the same user account. By leveraging location graph 500 and continuously updating location graph 500, location module 216 can determine whether a new login attempt is part of a primary location in real-time.

Returning to FIG. 1, at step 140, one or more of the systems described herein may perform, by the computing device, a security action for the login attempt based on the association with the user account. For example, a security module 218 may, as part of computing device 202 in FIG. 2, perform a security action 234 for login attempt 224 based on the association with user account 230.

The systems described herein may perform step 140 in a variety of ways. In some examples, security action 234 includes one or more of encrypting login attempt 224, determining a risk of the IP address is below a predetermined threshold, verifying a security of the direct connection, and/or verifying a security status of user account 230. As used herein, the term “encryption” generally refers to a process of transforming data to prevent unauthorized access. In the example of FIG. 3, by encrypting the assertion for login attempt 224, security module 218 provides and additional layer of security to avoid unauthorized access to user account 230. For example, a timestamp for login attempt 224 can confirm the subsequent login is from originating client device 206 and is within a predetermined time limit to ensure a freshness of a login decision. By evaluating the risk of the IP address or attribute 228, security module 218 can determine whether the network connection of client device 206 is a potential threat, such as via a public network. For example, by determining that the IP address of client device 206 is frequently used for multiple user accounts in location graph 500, security module 218 may determine the IP address is likely a public network and, therefore, exceeds the predetermined threshold for risk. For risky login attempts, additional credentials may be required.

Returning to FIG. 1, at step 150, one or more of the systems described herein may eliminate, by the computing device, a requirement of at least one user credential of the user account for the login attempt based on the security action. For example, an elimination module 220 may, as part of computing device 202 in FIG. 2, eliminate a requirement of user credential 236 of user account 230 for login attempt 224 based on security action 234.

The systems described herein may perform step 150 in a variety of ways. In some examples, user credential 236 may include a user identifier, an account identifier, a password, and/or a quick-response (QR) code. In the example of FIG. 3, user credential 236(1) of a user identifier is initially provided by user 208 as part of login attempt 224. After verifying that attribute 228 is associated with primary location 232 of FIG. 2 and perform security action 234 to confirm the IP address is not a risk, elimination module 220 can eliminate the requirement for an additional user credential 236(2) for a password. Similarly, in the example of FIG. 4, elimination module 220 can skip a prompt for a password and provide user 208 with an explanation that primary location 232 is detected for client device 206.

In alternate examples, as described above, computing device 202 can detect a connection to online service 210 and automatically compare attribute 228 to location graph 500 of FIG. 5 without requiring initial user credential 236(1). In these examples, elimination module 220 eliminates requirements for both user credential 236(1) and user credential 236(2), after performing security action 234 to confirm the location of client device 206 and the security of login attempt 224. In these examples, elimination module 220 can eliminate the requirement for any user input and automatically log in user 208 to user account 230.

Returning to FIG. 1, at step 160, one or more of the systems described herein may complete, by the computing device, the login attempt to the user account of the online service for the client device. For example, a login module 222 may, as part of computing device 202 in FIG. 2, complete login attempt 224 to user account 230 of online service 210 for client device 206.

The systems described herein may perform step 160 in a variety of ways. In some embodiments, login module 222 completes login attempt 224 by further performing an additional security action to verify client device 206. In these embodiments, the additional security action may include one or more of decrypting login attempt 224, notifying user 208 of user account 230 about login attempt 224 from client device 206, and/or verifying a timestamp of login attempt 224. In the example of FIG. 3, after elimination the requirement for a password, login module 222 uses security module 218 to decrypt login attempt 224 and verify the timestamp before formally logging in to online service 210. In this example, the decryption of previously encrypted login attempt 224 validates login attempt 224 during the login process. Thus, a security action 234(2) further confirms the security of login attempt 224 based on a previous security action 234(1). Additionally, by verifying the timestamp, login module 222 ensures the validation was recently performed, such that security action 234 has not expired and location graph 500 is not outdated. In these examples, login module 222 can then confirm the login to user 208. In other examples, login module 222 can send an alert to user 208 after logging in client device 206 to confirm the login is legitimate.

In some embodiments, the above described methods may further include detecting a new login attempt from client device 206, determining that client device 206 was previously logged out by user 208 of the user account 230, performing a security check for the new login attempt, and completing, based on the security check, the new login attempt to user account 230 of online service 210 for client device 206. In other words, computing device 202 detects previously used client devices in addition to new client devices. In the example of FIG. 2, detection module 212 further detects the new login attempt from client device 206, determination module 214 further determines that client device 206 was previously logged out by user 208 of user account 230, security module 218 performs a security check for the new login attempt, and login module 222 completes the new login attempt for client device 206, bypassing elimination module 220. In these embodiments, the security check includes one or more of requesting one or more user credentials of user account 230 during the new login attempt for client device 206, evaluating a previous logout of client device 206, and/or verifying a security status of user account 230. In these embodiments, the previous logout of client device 206 may indicate an error with user account 230, a change in primary location 232, a change in ownership of client device 206, a security breach, and/or any other change that may require additional user credentials to enforce account security.

As illustrated in FIG. 6, user 208 is notified of a previously detected logout. In this example, user 208 is then prompted to provide credential 236(2) to ensure user account 230 is still secure.

In one embodiment, security module 218 can further determine the new login attempt from client device 206 is associated with a different user account of online service 210. In this embodiment, login module 222 completes the new login attempt to the different user account instead. In this embodiment, location module 216 can further adjust a location graph of client devices based on security module 218 determining the new login attempt is associated with the different user account.

In the example of FIG. 7, a location graph 700 is updated from location graph 500 of FIG. 5 based on detecting client device 206(4) is associated with a user account 230(3) rather than a user account 230(1). In this example, user accounts 230(1)-(3) are associated with clusters 502(1)-(3), respectively. In this example, a new login attempt from client device 206(4) using network 204(3) may confirm client device 206(4) is associated with user account 230(3), thereby also changing cluster 502(1) to exclude client device 206(4). Thus, location graph 700 is continuously updated and adjusted from location graph 500 based on new login attempts. In various embodiments, location graph 500 and location graph 700 can also be adjusted based on types of devices, types of location-based attributes, types of user accounts, and/or any other suitable data.

As explained above in connection with method 100 in FIG. 1, the disclosed systems and methods, by building and utilizing a location graph based on client device logins, perform real-time evaluation of locations for client devices to reduce user input during login processes. Specifically, the disclosed systems and methods first track and build the location graph to cluster client devices in primary locations for each user account. For example, the disclosed systems and methods can use shared IP addresses to correlate different client devices as belonging to the same household. By detecting unique device identifier to track client devices, the systems and methods described herein can compare the location data of client devices with the location graph to determine whether the client devices belong to a known household. Additionally, by evaluating whether IP addresses are public or shared with multiple accounts, the systems and methods described herein can reduce risk by requiring additional credentials for devices using these IP addresses.

The disclosed systems and methods then eliminate the input of user credentials for client devices confirmed to be part of a household and to not pose a security risk. For example, the systems and methods described herein may skip the requirement of a password. In other words, by confirming the location and security of a device with backend security, the disclosed systems and methods can reduce the front-end burden to users. Thus, the systems and methods described herein may improve over traditional methods of manually logging in for client devices.

Content that is created or modified using the methods described herein may be used and/or distributed in a variety of ways and/or by a variety of systems. Such systems may include content distribution ecosystems, as shown in FIGS. 8-10.

FIG. 8 is a block diagram of a content distribution ecosystem 800 that includes a distribution infrastructure 810 in communication with a content player 820. In some embodiments, distribution infrastructure 810 may be configured to encode data and to transfer the encoded data to content player 820 via data packets. Content player 820 may be configured to receive the encoded data via distribution infrastructure 810 and to decode the data for playback to a user. The data provided by distribution infrastructure 810 may include audio, video, text, images, animations, interactive content, haptic data, virtual or augmented reality data, location data, gaming data, or any other type of data that may be provided via streaming.

Distribution infrastructure 810 generally represents any services, hardware, software, or other infrastructure components configured to deliver content to end users. For example, distribution infrastructure 810 may include content aggregation systems, media transcoding and packaging services, network components (e.g., network adapters), and/or a variety of other types of hardware and software. Distribution infrastructure 810 may be implemented as a highly complex distribution system, a single media server or device, or anything in between. In some examples, regardless of size or complexity, distribution infrastructure 810 may include at least one physical processor 812 and at least one memory device 814. One or more modules 816 may be stored or loaded into memory 814 to enable adaptive streaming, as discussed herein.

Content player 820 generally represents any type or form of device or system capable of playing audio and/or video content that has been provided over distribution infrastructure 810. Examples of content player 820 include, without limitation, mobile phones, tablets, laptop computers, desktop computers, televisions, set-top boxes, digital media players, virtual reality headsets, augmented reality glasses, and/or any other type or form of device capable of rendering digital content. As with distribution infrastructure 810, content player 820 may include a physical processor 822, memory 824, and one or more modules 826. Some or all of the adaptive streaming processes described herein may be performed or enabled by modules 826, and in some examples, modules 816 of distribution infrastructure 810 may coordinate with modules 826 of content player 820 to provide adaptive streaming of multimedia content.

In certain embodiments, one or more of modules 816 and/or 826 in FIG. 8 may represent one or more software applications or programs that, when executed by a computing device, may cause the computing device to perform one or more tasks. For example, and as will be described in greater detail below, one or more of modules 816 and 826 may represent modules stored and configured to run on one or more general-purpose computing devices. One or more of modules 816 and 826 in FIG. 8 may also represent all or portions of one or more special-purpose computers configured to perform one or more tasks.

Physical processors 812 and 822 generally represent any type or form of hardware-implemented processing unit capable of interpreting and/or executing computer-readable instructions. In one example, physical processors 812 and 822 may access and/or modify one or more of modules 816 and 826, respectively. Additionally or alternatively, physical processors 812 and 822 may execute one or more of modules 816 and 826 to facilitate adaptive streaming of multimedia content. Examples of physical processors 812 and 822 include, without limitation, microprocessors, microcontrollers, central processing units (CPUs), field-programmable gate arrays (FPGAs) that implement softcore processors, application-specific integrated circuits (ASICs), portions of one or more of the same, variations or combinations of one or more of the same, and/or any other suitable physical processor.

Memory 814 and 824 generally represent any type or form of volatile or non-volatile storage device or medium capable of storing data and/or computer-readable instructions. In one example, memory 814 and/or 824 may store, load, and/or maintain one or more of modules 816 and 826. Examples of memory 814 and/or 824 include, without limitation, random access memory (RAM), read only memory (ROM), flash memory, hard disk drives (HDDs), solid-state drives (SSDs), optical disk drives, caches, variations or combinations of one or more of the same, and/or any other suitable memory device or system.

FIG. 9 is a block diagram of exemplary components of content distribution infrastructure 810 according to certain embodiments. Distribution infrastructure 810 may include storage 910, services 920, and a network 930. Storage 910 generally represents any device, set of devices, and/or systems capable of storing content for delivery to end users. Storage 910 may include a central repository with devices capable of storing terabytes or petabytes of data and/or may include distributed storage systems (e.g., appliances that mirror or cache content at Internet interconnect locations to provide faster access to the mirrored content within certain regions). Storage 910 may also be configured in any other suitable manner.

As shown, storage 910 may store, among other items, content 912, user data 914, and/or log data 916. Content 912 may include television shows, movies, video games, user-generated content, and/or any other suitable type or form of content. User data 914 may include personally identifiable information (PII), payment information, preference settings, language and accessibility settings, and/or any other information associated with a particular user or content player. Log data 916 may include viewing history information, network throughput information, and/or any other metrics associated with a user's connection to or interactions with distribution infrastructure 810.

Services 920 may include personalization services 922, transcoding services 924, and/or packaging services 926. Personalization services 922 may personalize recommendations, content streams, and/or other aspects of a user's experience with distribution infrastructure 810. Encoding services, such as transcoding services 924, may compress media at different bitrates which may enable real-time switching between different encodings. Packaging services 926 may package encoded video before deploying it to a delivery network, such as network 930, for streaming.

Network 930 generally represents any medium or architecture capable of facilitating communication or data transfer. Network 930 may facilitate communication or data transfer via transport protocols using wireless and/or wired connections. Examples of network 930 include, without limitation, an intranet, a wide area network (WAN), a local area network (LAN), a personal area network (PAN), the Internet, power line communications (PLC), a cellular network (e.g., a global system for mobile communications (GSM) network), portions of one or more of the same, variations or combinations of one or more of the same, and/or any other suitable network. For example, as shown in FIG. 9, network 930 may include an Internet backbone 932, an internet service provider 934, and/or a local network 936.

FIG. 10 is a block diagram of an exemplary implementation of content player 820 of FIG. 8. Content player 820 generally represents any type or form of computing device capable of reading computer-executable instructions. Content player 820 may include, without limitation, laptops, tablets, desktops, servers, cellular phones, multimedia players, embedded systems, wearable devices (e.g., smart watches, smart glasses, etc.), smart vehicles, gaming consoles, internet-of-things (IoT) devices such as smart appliances, variations or combinations of one or more of the same, and/or any other suitable computing device.

As shown in FIG. 10, in addition to processor 822 and memory 824, content player 820 may include a communication infrastructure 1002 and a communication interface 1022 coupled to a network connection 1024. Content player 820 may also include a graphics interface 1026 coupled to a graphics device 1028, an audio interface 1030 coupled to an audio device 1032, an input interface 1034 coupled to an input device 1036, and a storage interface 1038 coupled to a storage device 1040.

Communication infrastructure 1002 generally represents any type or form of infrastructure capable of facilitating communication between one or more components of a computing device. Examples of communication infrastructure 1002 include, without limitation, any type or form of communication bus (e.g., a peripheral component interconnect (PCI) bus, PCI Express (PCIe) bus, a memory bus, a frontside bus, an integrated drive electronics (IDE) bus, a control or register bus, a host bus, etc.).

As noted, memory 824 generally represents any type or form of volatile or non-volatile storage device or medium capable of storing data and/or other computer-readable instructions. In some examples, memory 824 may store and/or load an operating system 1008 for execution by processor 822. In one example, operating system 1008 may include and/or represent software that manages computer hardware and software resources and/or provides common services to computer programs and/or applications on content player 820.

Operating system 1008 may perform various system management functions, such as managing hardware components (e.g., graphics interface 1026, audio interface 1030, input interface 1034, and/or storage interface 1038). Operating system 1008 may also process memory management models for playback application 1010. The modules of playback application 1010 may include, for example, a content buffer 1012, an audio decoder 1018, and a video decoder 1020.

Playback application 1010 may be configured to retrieve digital content via communication interface 1022 and play the digital content through graphics interface 1026. A video decoder 1020 may read units of video data from audio buffer 1014 and/or video buffer 1016 and may output the units of video data in a sequence of video frames corresponding in duration to the fixed span of playback time. Reading a unit of video data from video buffer 1016 may effectively de-queue the unit of video data from video buffer 1016. The sequence of video frames may then be rendered by graphics interface 1026 and transmitted to graphics device 1028 to be displayed to a user.

In situations where the bandwidth of distribution infrastructure 810 is limited and/or variable, playback application 1010 may download and buffer consecutive portions of video data and/or audio data from video encodings with different bit rates based on a variety of factors (e.g., scene complexity, audio complexity, network bandwidth, device capabilities, etc.). In some embodiments, video playback quality may be prioritized over audio playback quality. Audio playback and video playback quality may also be balanced with each other, and in some embodiments audio playback quality may be prioritized over video playback quality.

Content player 820 may also include a storage device 1040 coupled to communication infrastructure 1002 via a storage interface 1038. Storage device 1040 generally represent any type or form of storage device or medium capable of storing data and/or other computer-readable instructions. For example, storage device 1040 may be a magnetic disk drive, a solid-state drive, an optical disk drive, a flash drive, or the like. Storage interface 1038 generally represents any type or form of interface or device for transferring data between storage device 1040 and other components of content player 820.

Many other devices or subsystems may be included in or connected to content player 820. Conversely, one or more of the components and devices illustrated in FIG. 10 need not be present to practice the embodiments described and/or illustrated herein. The devices and subsystems referenced above may also be interconnected in different ways from that shown in FIG. 10. Content player 820 may also employ any number of software, firmware, and/or hardware configurations.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive login information to be transformed, transform the login information to create a location graph, output a result of the transformation to identify a client device's location, use the result of the transformation to eliminate a requirement for a user credential, and store the result of the transformation to service client devices of a content platform. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
detecting, by a computing device, a login attempt from a client device to an online service;
determining, based on a unique identifier of the client device, that the client device is associated with the online service;
determining, by the computing device, that an attribute of the client device is associated with a primary location of a user account of the online service;
performing, by the computing device, a security action for the login attempt based on the association with the user account;
eliminating, by the computing device, a requirement of at least one user credential of the user account for the login attempt based on the security action; and
completing, by the computing device, the login attempt to the user account of the online service for the client device.

2. The method of claim 1, wherein detecting the login attempt comprises at least one of:
detecting an initiation of a connection to the online service from the client device; or
identifying an initial user credential associated with the login attempt.

3. The method of claim 1, wherein determining that the client device is associated with the online service comprises comparing the unique identifier of the client device with a database of previous login attempts.

4. The method of claim 3, further comprising:
determining that the unique identifier of the client device does not match a previous login attempt; and
adding the unique identifier of the client device to the database of previous login attempts.

5. The method of claim 1, wherein determining that the attribute of the client device is associated with the primary location comprises comparing the attribute of the client device with a location graph.

6. The method of claim 5, wherein the location graph comprises a clustering of client devices, wherein each cluster represents the primary location of a set of client devices in the cluster, such that each user account is associated with one primary location.

7. The method of claim 6, wherein the location graph clusters the client devices based on similar attributes of the client devices during previous login attempts for each user account.

8. The method of claim 5, further comprising updating the location graph with the unique identifier of the client device based on determining that the attribute of the client device is associated with the primary location.

9. The method of claim 1, wherein the attribute of the client device comprises at least one of:
an Internet Protocol (IP) address; or
a direct connection to a different client device associated with the primary location of the user account.

10. The method of claim 9, wherein the security action comprises at least one of:
encrypting the login attempt;
determining a risk of the IP address is below a predetermined threshold;
verifying a security of the direct connection; or
verifying a security status of the user account.

11. The method of claim 1, wherein the user credential comprises at least one of:
a user identifier;
an account identifier;
a password; or
a quick-response (QR) code.

12. The method of claim 1, wherein completing the login attempt further comprises performing an additional security action to verify the client device.

13. The method of claim 12, wherein the additional security action comprises at least one of:
decrypting the login attempt;
notifying, by the computing device, a user of the user account about the login attempt from the client device; or
verifying a timestamp of the login attempt.

14. The method of claim 1, further comprising:
detecting, by the computing device, a new login attempt from the client device;
determining that the client device was previously logged out by a user of the user account;
performing a security check for the new login attempt; and
completing, based on the security check, the new login attempt to the user account of the online service for the client device.

15. The method of claim 14, wherein the security check comprises at least one of:
requesting the at least one user credential of the user account during the new login attempt for the client device;
evaluating a previous logout of the client device; or
verifying a security status of the user account.

16. A system comprising:
a detection module, stored in memory, that detects, by a computing device, a login attempt from a client device to an online service;
a determination module, stored in memory, that determines, based on a unique identifier of the client device, that the client device is associated with the online service;
a location module, stored in memory, that determines, by the computing device, that an attribute of the client device is associated with a primary location of a user account of the online service;
a security module, stored in memory, that performs, by the computing device, a security action for the login attempt based on the association with the user account;
an elimination module, stored in memory, that eliminates, by the computing device, a requirement of at least one user credential of the user account for the login attempt based on the security action;
a login module, stored in memory, that completes, by the computing device, the login attempt to the user account of the online service for the client device; and
at least one processor that executes the detection module, the determination module, the location module, the security module, the elimination module, and the login module.

17. The system of claim 16, wherein:
the detection module further detects a new login attempt from the client device;
the determination module further determines that the client device was previously logged out by a user of the user account;
the security module performs a security check for the new login attempt; and
the login module completes the new login attempt for the client device.

18. The system of claim 17, wherein:
the security module further determines the new login attempt from the client device is associated with a different user account of the online service; and
the login module completes the new login attempt to the different user account of the online service.

19. The system of claim 18, wherein the location module further adjusts a location graph of client devices based on the security module determining the new login attempt is associated with the different user account.

20. A non-transitory computer-readable medium comprising one or more computer-executable instructions that, when executed by at least one processor of a computing device, cause the computing device to:
detect, by the computing device, a login attempt from a client device to an online service;
determine, based on a unique identifier of the client device, that the client device is associated with the online service;
determine, by the computing device, that an attribute of the client device is associated with a primary location of a user account of the online service;
perform, by the computing device, a security action for the login attempt based on the association with the user account;
eliminate, by the computing device, a requirement of at least one user credential of the user account for the login attempt based on the security action; and
complete, by the computing device, the login attempt to the user account of the online service for the client device.
